(19) United States
(12) Patent Application Publication
(10) Pub. No.: US 2019/0111566 A1
(43) Pub. Date: Apr. 18, 2019

(54) INTELLIGENT ROBOT BASED ON ARTIFICIAL INTELLIGENCE

(71) Applicant: Beijing Baidu Netcom Science And Technology Co., Ltd., Beijing (CN)

(72) Inventors: Zhihao WANG, Beijing (CN); Yao LIU, Beijing (CN); Lun ZHANG, Beijing (CN)

(21) Appl. No.: 16/090,095

(22) PCT Filed: Dec. 21, 2016
(86) PCT No.: PCT/CN2016/111368

§ 371 Date: Sep. 28, 2018

(30) Foreign Application Priority Data
May 25, 2016 (CN) 201610353987.4

(51) Int. Cl. B25J 11/00; B25J 9/08; B25J 9/16

(52) U.S. Cl. CPC B25J 11/0005; B25J 9/1697; B25J 9/162; B25J 9/08

(57) ABSTRACT

The present disclosure provides an intelligent robot based on artificial intelligence. The intelligent robot (10) includes a plurality of components (11). Each component (11) has an independent function. Different components (11) can be detachable from each other and combinable.

### CROSS-REFERENCE TO RELATED APPLICATION

This application is a US national application of International Application No. PCT/CN2016/111368, filed Dec. 21, 2016, which claims priority to Chinese Patent Application No. 201610353987.4, filed with State Intellectual Property Office on May 25, 2016, entitled with “INTELLIGENT ROBOT BASED ON ARTIFICIAL INTELLIGENCE”, and filed by BEIJING BAIDU NETCOM SCIENCE AND TECHNOLOGY CO., LTD.

### FIELD

The present disclosure relates to the field artificial intelligence, and more particularly to an intelligent robot based on artificial intelligence.

### BACKGROUND

Artificial intelligence (AI for short) is a new technical science studying and developing theories, methods, techniques and application systems for simulating, extending and expanding human intelligence. The artificial intelligence is a branch of computer science, which attempts to know the essence of intelligence and to produce a new intelligent machine capable of acting in a same way as human intelligence. The researches in this field include robots, speech recognition, image recognition, natural language processing and expert systems, etc.

In the related art, intelligent robots are usually designed integrally. However, there are problems when the intelligent robots are designed integrally, for example, research and development cycle is long, functions are single, and updating cost is high.

### SUMMARY

The present disclosure provides an intelligent robot based on artificial intelligence.

The intelligent robot based on artificial intelligence according to embodiments of the present disclosure includes a plurality of components. Each component has an independent function, and different components are detachable from each other and combinable.

Additional aspects and advantages of embodiments of the present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a schematic diagram of an intelligent robot based on artificial intelligence according to an embodiment of the present disclosure.

FIG. 2 is a schematic diagram of an intelligent robot based on artificial intelligence according to another embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

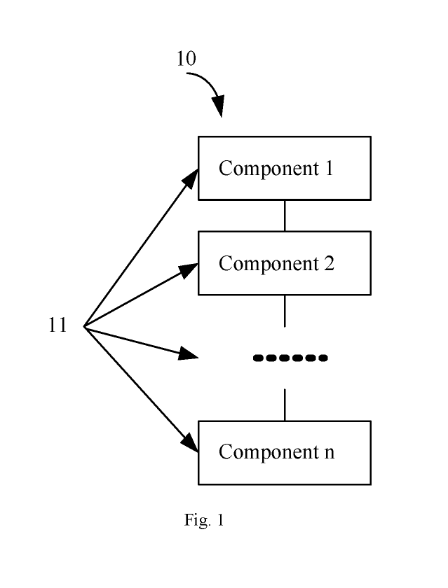

FIG. 1 is a schematic diagram of an intelligent robot based on artificial intelligence according to an embodiment of the present disclosure.

As illustrated in FIG. 1, the intelligent robot 10 includes a plurality of components 11. Each component has an independent function, and the different components are detachable from each other and combinable.

A component having an independent function means that the component can perform its own functions independently of other components.

For example, the component is an interactive system, the function of the interactive system is to interact with users, and then the interactive system having an independent function means that the interactive system can interact with users independently without the help of other components.

The fact that different components are detachable from each other means that the different components are independent of each other, and the intelligent robot can be split into a plurality of components without destroying it.

The fact that different components are combinable means that the different components can be combined with each other, to perform new functions.

In the present disclosure, “a plurality of” refers to at least two.

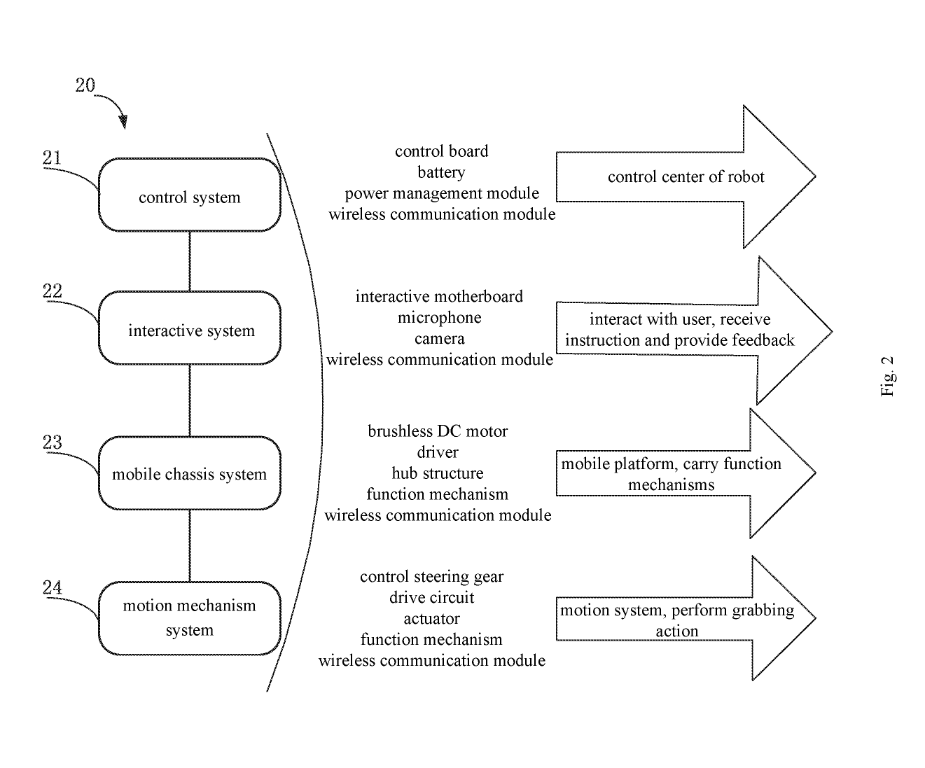

In some embodiments, referring to FIG. 2, the intelligent robot 20 includes a plurality of components. The plurality of components includes a control system 21, an interactive system 22, a mobile chassis system 23, and a motion mechanism system 24.

The control system 21 may include a control board, a battery, a power management module, and a wireless communication module.

The control system is a control center of the robot, and can control other components.

The interactive system may include an interactive motherboard, a microphone, a camera, and a wireless communication module.

The interactive system is configured to interact with users, receive instructions and provide feedback.

The mobile chassis system may include a brushless DC motor, a driver, a hub structure, a function mechanism, and a wireless communication module.

The mobile chassis system may be a mobile platform, which can carry function mechanisms.

The motion mechanism system may include a control steering gear, a drive circuit, an actuator, a function mechanism, and a wireless communication module.

The motion mechanism system may be a motion system, which can perform actions such as grabbing.

The above-mentioned components and systems may be connected via a standard component interface and a serial line, which can complete assembling and dissembling in a short time.

When the components are separated ones, they can independently provide service for users. For example, the interactive system can interact with users, to provide users with functions such as chatting. The interactive system can be mobile and portable.

When the components are combined, they can cooperate with each other to provide service for the user. For example, when a user needs a cup of coffee, the user can send an instruction to the interactive system, the interactive system can send the instruction to the control system, the control system can send the instruction to the mobile chassis system, the mobile chassis system can drive the function mechanism to move, and the function mechanism can carry the coffee to the user.

In addition, the different components may also perform their respective functions while providing service for the user. For example, a user A can chat through the interactive system, and a user B can obtain coffee by driving the function mechanism through the mobile chassis system, or the like.

Furthermore, when all the components are combined, it can interact with users as a humanoid large artificial intelligence robot and can complete tasks that require the entire robot (such as “dancing” with users after performing face recognition and motion capture).

In embodiments of the present disclosure, the intelligent robot includes a plurality of components having an independent function. Since the components are independent of each other, research and development can be independently developed, and the research and development cycle can be shortened. Respective components can have functional expansibility, and can carry different systems. Moreover, the components can be combined based on different needs to adapt to different situations. The plurality of components can be updated independently, such that cost of iteration can be reduced, and the speed of iteration can be improved.

It should be noted that, in descriptions of the present disclosure, terms such as “first” and “second” are used herein for purposes of description and are not construed as indicating or implying relative importance or significance. Furthermore, in the description of the present disclosure, “a plurality of” refers to two or more than two unless it is specified otherwise.

Any procedure or method described in the flow charts or described in any other way herein may be understood to comprise one or more modules, portions or parts for storing executable codes that realize particular logic functions or procedures. Moreover, advantageous embodiments of the present disclosure comprises other implementations in which the order of execution is different from that which is depicted or discussed, including executing functions in a substantially simultaneous manner or in an opposite order according to the related functions, which should be understood by those skilled in the art.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks or CD, etc.

In the description of the present disclosure, reference throughout this specification to “an embodiment,” “some embodiments,” “example,” “a specific example,” or “some examples,” means that a particular feature, structure, material, or characteristic described in connection with the embodiment or example is included in at least one embodiment or example of the present disclosure. In the specification, the terms mentioned above are not necessarily referring to the same embodiment or example of the present disclosure. Furthermore, the particular features, structures, materials, or characteristics may be combined in any suitable manner in one or more embodiments or examples. Besides, any different embodiments and examples and any different characteristics of embodiments and examples may be combined by those skilled in the art without contradiction.

Although explanatory embodiments have been illustrated and described, it would be appreciated by those skilled in the art that the above embodiments are exemplary and cannot be construed to limit the present disclosure, and changes, modifications, alternatives and varieties can be made in the embodiments by those skilled in the art without departing from scope of the present disclosure.

1. An intelligent robot based on artificial intelligence, comprising:
a plurality of components;
wherein each component has an independent function;
different components are detachable from each other and combinable.

2. The intelligent robot according to claim 1, wherein the plurality of components comprise:
a control system, an interactive system, a mobile chassis system, and a motion mechanism system.

3. The intelligent robot according to claim 2, wherein the control system comprises:
a control board, a battery, a power management module, and a wireless communication module.

4. The intelligent robot according to claim 2, wherein the interactive system comprises:
an interactive motherboard, a microphone, a camera, and a wireless communication module.

5. The intelligent robot according to claim 2, wherein the mobile chassis system comprises:
a brushless DC motor, a driver, a hub structure, a function mechanism, and a wireless communication module.

6. The intelligent robot according to claim 2, wherein the motion mechanism system comprises:
a control steering gear, a drive circuit, an actuator, a function mechanism, and a wireless communication module.

7. The intelligent robot according to claim 1, wherein the different components are connected via a standard component interface and a serial line.

8. The intelligent robot according to claim 3, wherein the interactive system comprises:
an interactive motherboard, a microphone, a camera, and a wireless communication module.

9. The intelligent robot according to claim 3, wherein the mobile chassis system comprises:
a brushless DC motor, a driver, a hub structure, a function mechanism, and a wireless communication module.

10. The intelligent robot according to claim 4, wherein the mobile chassis system comprises:
a brushless DC motor, a driver, a hub structure, a function mechanism, and a wireless communication module.

11. The intelligent robot according to claim 3, wherein the motion mechanism system comprises:
a control steering gear, a drive circuit, an actuator, a function mechanism, and a wireless communication module.

12. The intelligent robot according to claim 4, wherein the motion mechanism system comprises:
a control steering gear, a drive circuit, an actuator, a function mechanism, and a wireless communication module.

13. The intelligent robot according to claim 5, wherein the motion mechanism system comprises:
a control steering gear, a drive circuit, an actuator, a function mechanism, and a wireless communication module.

14. The intelligent robot according to claim 2, wherein the different components are connected via a standard component interface and a serial line.

15. The intelligent robot according to claim 3, wherein the different components are connected via a standard component interface and a serial line.

16. The intelligent robot according to claim 4, wherein the different components are connected via a standard component interface and a serial line.

17. The intelligent robot according to claim 5, wherein the different components are connected via a standard component interface and a serial line.

18. The intelligent robot according to claim 6, wherein the different components are connected via a standard component interface and a serial line.
